(19) United States
(12) Patent Application Publication
(10) Pub. No.: US 2025/0382017 A1
(43) Pub. Date: Dec. 18, 2025

(54) VEHICLE REAR FLOOR ASSEMBLY WITH SUBFRAME CATCHER

(71) Applicant: FORD GLOBAL TECHNOLOGIES, LLC, Dearborn, MI (US)

(72) Inventors: Peyman AGHSSA, Ann Arbor, MI (US); Ga Ram JUN, Ann Arbor, MI (US); Vladimir Vladimirovich BOGACHUK, West Bloomfield, MI (US); Sean Timothy RYAN, Farmington Hills, MI (US); Ali KANBEROGLU, Plymouth, MI (US); Bin ZHANG, Northville, MI (US); Aron GRAJEK, Northville, MI (US); Vijay PACHORE, Troy, MI (US); Scott MAIR, Dearborn, MI (US)

(21) Appl. No.: 18/742,482

(22) Filed: Jun. 13, 2024

(51) Int. Cl. B62D 25/20; B60L 50/60

(52) U.S. Cl. CPC B62D 25/2027; B60L 50/66

(57) ABSTRACT

An electric vehicle includes a monolithic rear floor assembly having a front cross member with an underside having an integral catcher formed thereon. The catcher has a pair of angled sidewalls joined at a contact nose of the catcher that faces a rear of the vehicle. A traction battery is disposed forward of the front cross member. A subframe is attached under the rear floor assembly and includes a cross beam spaced rearwardly from the contact nose of the catcher. The contact nose of the catcher is configured to engage with the subframe to limit forward movement of the subframe towards the battery.

### TECHNICAL FIELD

This disclosure relates to motor vehicles and more particularly to a rear floor assembly with a catcher configured to inhibit movement of a subframe.

### BACKGROUND

Vehicles traditionally had a frame and a body supported on the frame. Today, many light-duty passenger vehicles have a unibody construction in which the body and frame are formed together as a unitary assembly. Unibody construction typically includes multiple steel stampings that are welded together.

### SUMMARY

According to one embodiment, an electric vehicle includes a monolithic rear floor assembly having a front cross member with an underside including an integral catcher formed thereon. The catcher has a pair of angled sidewalls joined at a contact nose of the catcher that faces a rear of the vehicle. A traction battery is disposed forward of the front cross member. A subframe is attached under the rear floor assembly and includes a cross beam spaced rearwardly from the contact nose of the catcher. The contact nose of the catcher is configured to engage with the subframe to limit forward movement of the subframe towards the battery.

According to another embodiment, an electric vehicle includes a rear floor assembly having a cross member with a plurality of triangular reinforcements arranged along a length of the cross member. Each of the triangular reinforcements have a contact nose facing a rear of the vehicle and a pair of angled sidewalls extending from the nose towards a front of the vehicle. A traction battery is disposed forward of the cross member. A subframe is attached under the rear floor assembly and includes a cross beam spaced rearwardly from the contact noses. The contact noses are configured to engage with the subframe to limit forward movement of the subframe towards the battery.

According to yet another embodiment, a die-cast rear floor assembly includes a front cross member and a catcher integrally formed on an underside of the cross member. The catcher has a contact nose facing rearwardly and a pair of angled sidewalls joined at the nose and extending forwardly therefrom. The catcher further has a reinforcing projection disposed behind the nose.

### BRIEF DESCRIPTION OF THE DRAWINGS

FIG. 1 is a diagrammatical view of an electric vehicle with a rear floor assembly according to one or more embodiments of this disclosure.

FIG. 2 is a partial perspective view of an underside of the vehicle of FIG. 1 showing the battery assembly compartment, rear floor assembly, and rear subframe.

FIG. 3 is a bottom perspective view of a front portion of the rear floor assembly.

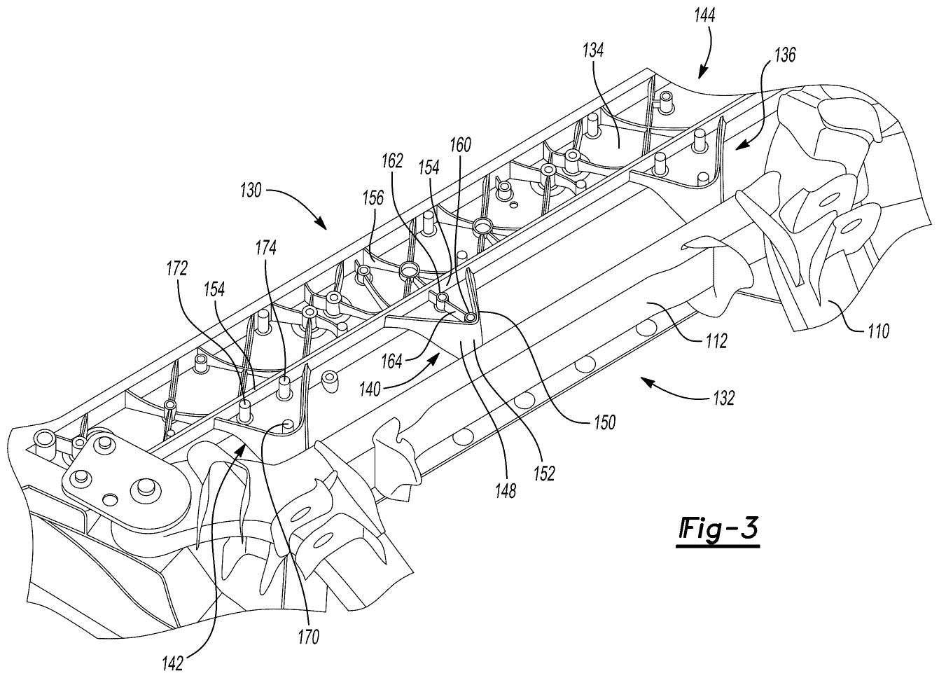

### DETAILED DESCRIPTION

Embodiments of the present disclosure are described herein. It is to be understood, however, that the disclosed embodiments are merely examples and other embodiments can take various and alternative forms. The figures are not necessarily to scale; some features could be exaggerated or minimized to show details of particular components. Therefore, specific structural and functional details disclosed herein are not to be interpreted as limiting, but merely as a representative basis for teaching one skilled in the art to variously employ the present invention. As those of ordinary skill in the art will understand, various features illustrated and described with reference to any one of the figures can be combined with features illustrated in one or more other figures to produce embodiments that are not explicitly illustrated or described. The combinations of features illustrated provide representative embodiments for typical applications. Various combinations and modifications of the features consistent with the teachings of this disclosure, however, could be desired for particular applications or implementations.

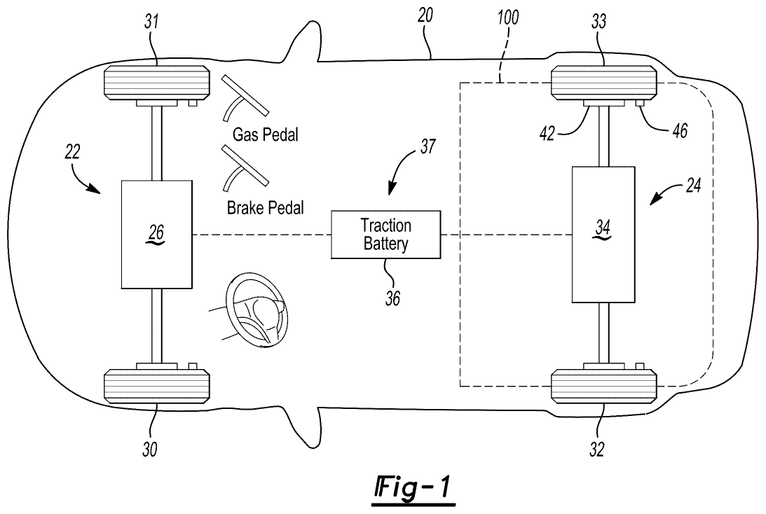

Referring to FIG. 1, an electrified vehicle 20 is illustrated as a fully electric vehicle but, in other embodiments, the electrified vehicle 20 may be a hybrid-electric vehicle that includes an internal-combustion engine. The vehicle 20 has electric all-wheel drive (AWD) but may be front- or rear-wheel drive in other embodiments. The vehicle 20 may include a primary drive axle 24 and a secondary drive axle 22. In the illustrated embodiment, the primary drive axle 24 is the rear axle and the secondary drive axle 22 is the front axle. In other embodiments, the front axle may be the primary drive and the rear axle may be the secondary drive. The primary and secondary axles may include their own powerplant, e.g., an electric machine, and are capable of operating independently of each other or in tandem to accelerate (propel) or brake the vehicle 20.

The secondary drive axle 22 may include at least one powerplant, e.g., electric machine 28, operable to power the secondary wheels 30 and 31. A gearbox (not shown) may be included to change a speed ratio between the wheels 30, 31 and the powerplant(s). The primary drive axle 24 may include at least one powerplant, e.g., an electric machine 34, that is operably coupled to the primary wheels 32 and 33. A gearbox (not shown) may be included change a speed ratio between the powerplant(s) 34 and the wheels 32, 33. While not illustrated, the vehicle 20 could also include four electric machines, each mounted to one of the wheels.

The electric machines 28, 34 are powered by one or more traction batteries, such as traction battery 36, which may be centrally located between the front and rear axles 22, 24 and under the passenger cabin of the vehicle 20. The traction battery 36 stores energy that can be used by the electric machines 28, 34. The traction battery 36 provides a high-voltage direct current (DC) output from one or more battery cell arrays, sometimes referred to as battery cell stacks, within the traction battery 36. The battery cell arrays include one or more battery cells. The battery cells, such as a prismatic, pouch, cylindrical, or any other type of cell, convert stored chemical energy to electrical energy. The cells may include a housing, a positive electrode (cathode), and a negative electrode (anode). An electrolyte allows ions to move between the anode and cathode during discharge, and then return during recharge. Terminals may allow current to flow out of the cell for use by the vehicle 20. Different battery pack configurations may be available to address individual vehicle variables including packaging constraints and power requirements. The battery cells may be thermally regulated with a thermal management system.

The traction battery 36 may be electrically connected to one or more power-electronics modules through one or more contactors. The module may be electrically connected to the electric machines 28, 34 and may provide the ability to bi-directionally transfer electrical energy between the traction battery 36 and the electric machines 28, 34. For example, the traction battery 36 may provide a DC voltage while the electric machines 28, 34 may require a three-phase AC voltage to function. The power-electronics module may convert the DC voltage to a three-phase AC voltage as required by the electric machines. In a regenerative mode, the power-electronics module may convert the three-phase AC voltage from the electric machines 28, 34 acting as generators to the DC voltage required by the traction battery 36. The battery 36, power electronics, and other electrical components may be packaged within one or more housings located in a battery compartment 37. The battery compartment 37 may be under the floor of the vehicle 20 and between side rails of the vehicle frame or unibody structure.

The vehicle 20 may include unibody construction, also known as monocoque construction. Unibody is a structural approach where the body of a vehicle and its frame are integrated into a single, cohesive unit. This design contrasts with traditional body-on-frame construction, where the body and frame are separate components attached to each other using body mounts. The integration of the body and frame may increase structural rigidity of the vehicle, streamline the manufacturing process since fewer components are needed, and allow for more precise tolerances.

In one or more embodiments, the vehicle 20 has unibody construction and generally includes a front structure, a middle structure, and a rear structure. The front structure may include front longitudinal frame rails, cross members, and a front subframe for mounting the front axle 22 and its associated components including powerplant 26 and the front suspension. The passenger compartment may be part of the middle structure and may include A-pillars, B-pillars, roof rails, floor pans, and side sills. The rear structure may include rear longitudinal frame rails, cross members, and a rear floor assembly supporting the rear axle 24 and providing structural integrity. The rear floor assembly provides support and rigidity to the rear of the vehicle and may include the trunk floor, rear floor of the passenger cabin, wheel wells, and various reinforcements designed to handle loads from the rear suspension, cargo, and, in some cases, the fuel tank.

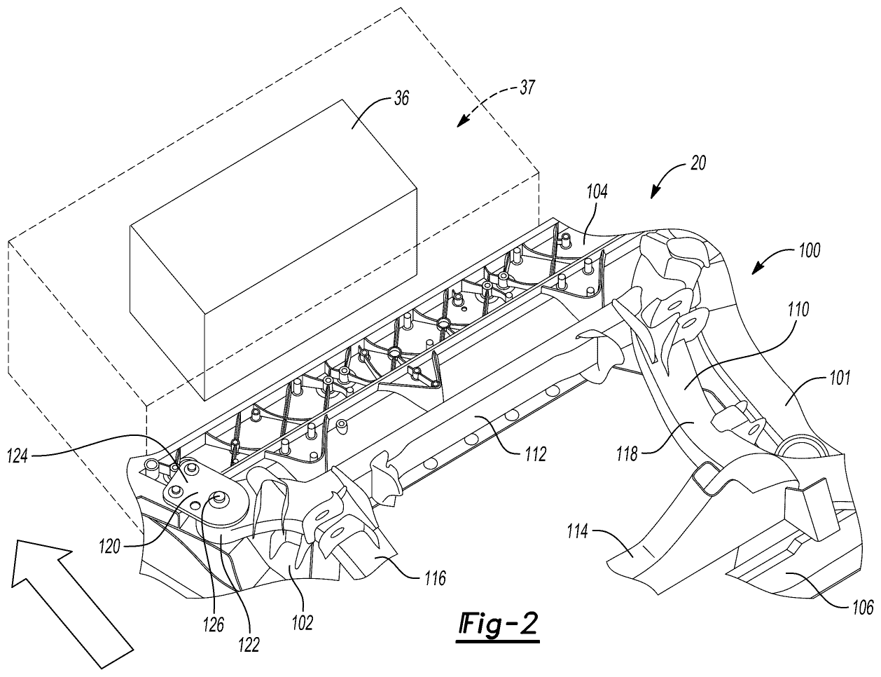

Referring to FIGS. 1 and 2, the vehicle 20 includes a rear floor assembly 100 that supports the rear portion of the vehicle. The rear floor assembly 100 may be a portion of the vehicle's unibody chassis. In one or more embodiments, the rear floor assembly 100 is a monolithic casting, such as an aluminum casting. The aluminum casting may be formed by die casting or high-pressure die casting techniques. This monolithic construction—meaning that all components are integrally formed with each other—contrasts with traditional construction in which the rear floor assembly is formed of dozens of metal stampings that are welded to each other. By utilizing a casting, the rear floor assembly 100 is a single part instead of being an assembly of 70 to 100 individual parts welded together. This may reduce weight, complexity, and assembly time while providing performance benefits such as strength, rigidity, and the like.

The rear floor assembly 100 may include a pair of opposing side members 101 and 102 that extend in the longitudinal direction of the vehicle 20. A front cross member 104 extends between the side members 101, 102 as does a rear cross member 106. The front cross member 104 includes attachments (not shown) that connect with a chassis structure (not shown) of the vehicle. In one or more embodiments, the rear floor assembly 100 is fastened to the chassis structure via bolts, rivets, or the like or, in other embodiments, may be welded.

The battery compartment 37, including the traction battery 36, is located just forward of the rear floor assembly 100. The front cross member 104 includes a forward side 130 adjacent to the battery compartment 37, a rear side 132, and an underside 134.

A rear subframe 110 is disposed under the rear floor assembly 100. The subframe 110 includes a forward cross beam 112, a rear cross beam 114, and side beams 116 and 118 that connect between the front beam 112 and the rear beam 114. The subframe 110 is disposed between the front cross member 104, the rear cross member 106, and side members 101, 102. For example, the front cross beam 112 extends substantially parallel to the front cross member 104 and is adjacent to the rear side 132 of the front cross member. The rear cross beam 114 is substantially parallel to the rear cross member 106 and may be disposed directly underneath the cross member 106, or forward or rearward of the cross member 106. The side beams 116, 118 may be substantially parallel to the side members 101 and 102 and may be located laterally inboard of the side members 101,102.

The subframe 110 supports the rear axle 24 and includes attachment areas for connecting with the rear suspension system. The subframe 110 is mounted to the rear floor assembly 100 by bushing assemblies 120. For example, the four corners of the subframe 110 may each include a bushing assembly 120 connecting the subframe 110 to the rear floor assembly 100. Each of the bushing assemblies 120 may include bushing 122 formed of resilient material (e.g., rubber), a mounting plate 124, and a bolt 126 that extends through the mounting plate 124, the bushing 122, and is threadably engaged with a tapped hole of the rear floor assembly 100. The bushings 122 allow for movement of the subframe 110 relative to the rear floor assembly 100.

The flexibility provided by the bushings 122 may allow forward movement of the subframe 110 into the front cross member 104 of the rear floor assembly 100. As such, the rear floor assembly 100 includes at least one catcher 136 located on the underside of the front cross member 104. The catcher 136 is configured to engage with the front beam 112 of the subframe 110 should the subframe shift forwardly responsive to a forward external force acting thereon. This limits movement of the subframe 110 towards the battery compartment 37. The at least one catcher 136 is a structural reinforcement designed to absorb the front beam 112. In embodiments where the rear floor assembly 100 is a casting, the catcher(s) 136 are an integrally formed portion of the casting.

In the illustrated embodiment, the front cross member 104 includes three catchers 136, a central catcher 140, a first outer catcher 142, and a second outer catcher 144. In the illustrated embodiment, the outer catchers 142, 144 are the same, whereas the central catcher 140 is different. In other embodiments, all three catchers 136 may be the same, or all three catchers may differ. Three is merely an example number of catchers 136 and more or fewer may be included in other embodiments.

Each of the catchers 136 may include angled sidewalls 148 and 150 that are joined at a contact nose 152. The contact noses 152 face rearwardly and are adjacent to a front side of the forward cross beam 112. The contact noses 152 are the portion of the catchers 136 designed to contact the subframe 110. In the illustrated embodiment, the sidewalls 148 and 150 form an acute angle therebetween. The sidewalls 148, 150 extend forwardly from the contact noses 152 and terminate at a base wall 154 of the catcher 136 creating a triangular reinforcement structure. The base wall 150 may be a stand-alone wall or maybe a portion of a wall of the front cross member 104 as shown in the illustrated embodiment. The base wall 154 may be reinforced with ribbing 156.

The catchers 136 may further include reinforcing structure such as projections, ribbing, or the like. In the illustrated embodiment, the central catcher 140 has a different combination of projections and ribbing than the outer catchers 142, 144. For example, the central catcher 140 includes a first projection 160 (e.g., a hollow, circular cylinder) formed at the nose 152, a second projection 162 spaced forwardly (in the direction of the vehicle) from the projection 160, and one or more ribs 164 extending from the first projection 162 to the base wall 154 and intersecting with the second projection 162. The first outer catcher 142 may include one or more projections in the form of circular cylinders, which may be solid or hollow. In the illustrated example, the outer catcher 142 includes a triangular arrangement of projections including a first projection 170 located behind the contact nose 152, a second projection 172 located adjacent to the base wall 154, and a third projection 174 located adjacent to the base wall 154. The second and third projections 172, 174 are generally located in the corners created between the sidewalls 148, 150 and the base wall 154. The triangular arrangement of projections is disposed within the triangular perimeter of the catcher 142. The second outer catcher 144 may be the same as the first outer catcher 142 and will not be explained again for brevity.

As discussed above, the rear floor assembly 100 may be a casting, such as an aluminum casting, creating a monolithic structure. In this embodiment, the catchers, along with all their associated subcomponents, are all integrally formed with each other and with the rear floor assembly to simplify construction and improve performance as described above.

While exemplary embodiments are described above, it is not intended that these embodiments describe all possible forms encompassed by the claims. The words used in the specification are words of description rather than limitation, and it is understood that various changes can be made without departing from the spirit and scope of the disclosure. As previously described, the features of various embodiments can be combined to form further embodiments of the invention that may not be explicitly described or illustrated. While various embodiments could have been described as providing advantages or being preferred over other embodiments or prior art implementations with respect to one or more desired characteristics, those of ordinary skill in the art recognize that one or more features or characteristics can be compromised to achieve desired overall system attributes, which depend on the specific application and implementation. These attributes can include, but are not limited to strength, durability, marketability, appearance, packaging, size, serviceability, weight, manufacturability, ease of assembly, etc. As such, embodiments described as less desirable than other embodiments or prior art implementations with respect to one or more characteristics are not outside the scope of the disclosure and can be desirable for particular applications.

What is claimed is:

1. An electric vehicle comprising:
a monolithic rear floor assembly including a front cross member having an underside with an integral catcher formed thereon, the catcher having a pair of angled sidewalls joined at a contact nose of the catcher that faces a rear of the vehicle;
a traction battery disposed forward of the front cross member; and
a subframe attached under the rear floor assembly and including a cross beam spaced rearwardly from the contact nose of the catcher, wherein the contact nose of the catcher is configured to engage with the subframe to limit forward movement of the subframe towards the battery.

2. The electric vehicle of claim 1, wherein the catcher further has a reinforcing projection disposed behind the contact nose.

3. The electric vehicle of claim 1, wherein the catcher further has a base wall interconnected with the sidewalls to from a triangular structure.

4. The electric vehicle of claim 3, wherein the catcher further has a reinforcing projection disposed behind the contact nose.

5. The electric vehicle of claim 3, wherein the catcher further has a triangular arrangement of reinforcing projections disposed within a perimeter formed by the sidewalls and base wall, wherein the triangular arrangement of reinforcing projections includes a first projection disposed behind the contact nose and second and third projections disposed adjacent to the base wall.

6. The electric vehicle of claim 5, wherein the projections are circular cylinders.

7. The electric vehicle of claim 3, wherein the catcher further has a rib extending from the nose to the base wall.

8. The electric vehicle of claim 7, wherein the catcher further has a projection intersecting the rib.

9. The electric vehicle of claim 1, wherein the catcher is a plurality of catchers disposed along the front cross member.

10. The electric vehicle of claim 1, wherein an angle between the angled sidewalls is acute.

11. The electric vehicle of claim 1 further comprising bushing assemblies connecting the subframe to the rear floor assembly.

12. The electric vehicle of claim 1, wherein the rear floor assembly is an aluminum casting.

13. An electric vehicle comprising:
a rear floor assembly including a cross member having a plurality of triangular reinforcements arranged along a length of the cross member, each of the triangular reinforcements having a contact nose facing a rear of the vehicle and a pair of angled sidewalls extending from the nose toward a front of the vehicle;
a traction battery disposed forward of the cross member; and
a subframe attached under the rear floor assembly and including a cross beam spaced rearwardly from the contact noses, wherein the contact noses are configured to engage with the subframe to limit forward movement of the subframe towards the battery.

14. The electric vehicle of claim 13, wherein at least one of the triangular reinforcements has a reinforcing projection disposed behind the contact nose.

15. The electric vehicle of claim 14, wherein at least one of the triangular reinforcements has a rib extending forwardly from the contact nose.

16. The electric vehicle of claim 13, wherein at least one of the triangular reinforcements has a triangular arrangement of reinforcing projections disposed within a perimeter thereof.

17. The electric vehicle of claim 13, wherein the rear floor assembly is an aluminum casting.

18. A die-cast rear floor assembly comprising:
a front cross member; and
a catcher integrally formed on an underside of the cross member, the catcher having a contact nose facing rearwardly and a pair of angled sidewalls joined at the nose and extending forwardly therefrom, the catcher further having a reinforcing projection disposed behind the nose.

19. The die-cast rear floor assembly of claim 18, wherein the catcher has a base wall interconnecting between the sidewalls to from a triangular structure.

20. The die-cast rear floor assembly of claim 19, wherein the catcher further has two additional reinforcing projections disposed adjacent to the base wall and forming a triangular arrangement with the reinforcing projection.
